(19) United States
(12) Patent Application Publication
(10) Pub. No.: US 2006/0047574 A1
(43) Pub. Date: Mar. 2, 2006

(54) Methods and systems for managing hierarchically organized objects in a pricing adjustment system

(76) Inventors: Shankar Sundaram, San Jose, CA (US); Michael J. Klein, Palo Alto, CA (US); Narayanan Vijaykumar, Cupertino, CA (US)

Correspondence Address: Kang S. Lim, 3494 Camino Tassajara Road, #436, Danville, CA, 94506, US

(21) Appl. No.: 10/929,358

(22) Filed: Aug. 27, 2004

(51) Int. Cl. G06Q 30/00

(52) U.S. Cl. 705/26

(57) ABSTRACT

To achieve the foregoing and in accordance with the present invention, methods and systems of overriding inherited pricing structure properties in a hierarchically organized integrated price adjustment system are presented. The methods include the steps of providing hierarchically organized product line pricing structures in a common inheritance path where one hierarchically organized product line pricing structures is a root level product line pricing structure and where all other hierarchically organized product line pricing structures are configured to inherit at least one property from the root level product line pricing structure; modifying, by user input, a property of a hierarchically organized product line pricing structures; updating all hierarchically organized product line pricing structures above the product line pricing structure having the modified property where only product line pricing structures in the common inheritance path are updated such that hierarchical inheritance is overridden.

### BACKGROUND OF THE INVENTION

Automated pricing systems permeate modem businesses. The ability to flexibly respond to changing markets and reflect those changes in pricing as soon as possible allows business to preserve shrinking margins in highly competitive markets. A key issue pertaining to automated systems is the ability to apply consistent pricing logic across any number of products or product groups. Consistent pricing logic is more efficient in terms of speed and in terms of code maintenance. With respect to speed, consistent pricing logic may reduce the number of actual lines of code needing to be addressed for any given product. Thus processing power may be reserved for other computational needs. In terms of code maintenance, consistent pricing logic allows for changes to be timely implemented without the need to hunt down disparate pricing methods across an entire enterprise system.

However, consistent pricing logic is not without its attendant restrictions. For example, under some circumstances and in some automated pricing environments, it may be difficult or impossible to modify an individual transaction without inadvertently causing a ripple effect to other related products. This may arise either because the effect was unanticipated or because a supervening priority precludes the possibility. In the first case, consistent pricing logic may help to solve an unanticipated problem efficiently since a single change may be enacted in a logical construct that extends to the entire enterprise. In the latter case, a supervening priority may be addressed by first examining the relevant business objectives and then incorporating the result of that examination in a consistent way by either modifying existing logic or by creating new, compatible logic.

When pricing logic is modified or new compatible logic is created, certain general rules apply as can be appreciated by one skilled in the programming arts. One such construct is inheritance. For example, in object-oriented programming, inheritance is the ability to derive new classes from existing classes. A derived class (or “subclass”) inherits the instance variables and methods of the “base class” (or “superclass”), and may add new instance variables and methods. New methods may be defined with the same names as those in the base class, in which case they override the original one. In this manner, data integrity is preserved across any number of classes. Inheritance raises issues in an instance where pricing logic utilizes objects as constructs of pricing data. That is, a line item may be configured as an object that may be manipulated in a logical construct rather than as a string that may be acted upon by a process. Utilizing this methodology allows pricing logic to be applied consistently across an object and its progeny. However, when an inherited property of a progeny is modified in response to user decisions, then the standard rules of inheritance are violated. Conventionally, this type of violation is not allowable. In the context of a pricing adjustment system, inheritance rules would preclude the ability to change prices that exist on a lower level of a product set where product pricings are configured as objects.

For example, in a price quotation context, all pricing may not be available early in the life cycle of a transaction. This is particularly true in early stages of transactions where a vendor may or may not know the exact product configuration details, but where an early quote is, nevertheless, required. Thus, it may be desirable to able to price at a higher level and to price exclusions for known details while preserving the ability to price at lower levels as more details become known.

Thus, methods and systems for managing hierarchically organized objects in a pricing adjustment system are presented.

### SUMMARY OF THE INVENTION

To achieve the foregoing and in accordance with the present invention, a method of overriding inherited pricing structure properties in a hierarchically organized integrated price adjustment system is presented comprising the steps of providing hierarchically organized product line pricing structures in a common inheritance path where one hierarchically organized product line pricing structures is a root level product line pricing structure and where all other hierarchically organized product line pricing structures are configured to inherit at least one property from the root level product line pricing structure; modifying, by user input, a property of a hierarchically organized product line pricing structures; updating all hierarchically organized product line pricing structures above the product line pricing structure having the modified property where only product line pricing structures in the common inheritance path are updated such that hierarchical inheritance is overridden.

In one embodiment, a system for overriding inherited pricing structure properties in a hierarchically organized integrated price adjustment system comprising: a database populated with objects representing products in a product line where the objects are hierarchically organized within related product line hierarchies and where the objects are configured to inherit an inherited pricing structure property is presented. The system also includes a user interface configured to allow an inherited pricing structure property in a one product line to be modified in accordance with user preferences and an update engine that overrides all inherited pricing structure properties of all objects above the object having the modified pricing structure property in the related product line hierarchy.

In some embodiments, a computer program product in a computer readable media for overriding inherited pricing structure properties in a hierarchically organized integrated price adjustment system is presented. The computer program product comprises a database populated with objects representing products in a product line where the objects are hierarchically organized within related product line hierarchies and where the objects are configured to inherit an inherited pricing structure property. The computer program product also includes a user interface configured to allow a inherited pricing structure property in a one product line to be modified in accordance with user preferences and an update engine that overrides all inherited pricing structure properties of all objects above the object having the modified pricing structure property in the related product line hierarchy.

In still other embodiments, a method of overriding inherited object properties in a hierarchically organized integrated price adjustment system is presented. The method comprises the steps of: providing hierarchically organized objects in a common inheritance path where one hierarchically organized object is a root level object and where all other hierarchically organized objects are configured to inherit a property from the root level object; modifying, by user input, one of the properties of any of the hierarchically organized objects; updating all hierarchically organized objects above the object having the modified property where only objects in the common inheritance path are updated such that hierarchical inheritance is overridden.

Note that the various features of the present invention, including the methods, systems, and computer program products disclosed herein can be practiced alone or in combination. These and other features of the present invention will be described in more detail below in the detailed description of the invention and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a graphical illustration representing a product hierarchy.

FIG. 2 is a flowchart representing a method of making overrides in a hierarchically organized pricing model according to an embodiment of the present invention.

FIG. 3 is a flowchart representing a generating a proposal according to an embodiment of the present invention.

FIG. 4 is an example hierarchy of nested lined items along with sample data in one embodiment of the present invention

FIG. 5 is a flowchart representing a generating a proposal according to an embodiment of the present invention.

FIG. 6 is an example user interface in accordance with an embodiment of the present invention.

### DETAILED DESCRIPTION OF THE INVENTION

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention. The features and advantages of the present invention may be better understood with reference to the drawings and discussions that follow.

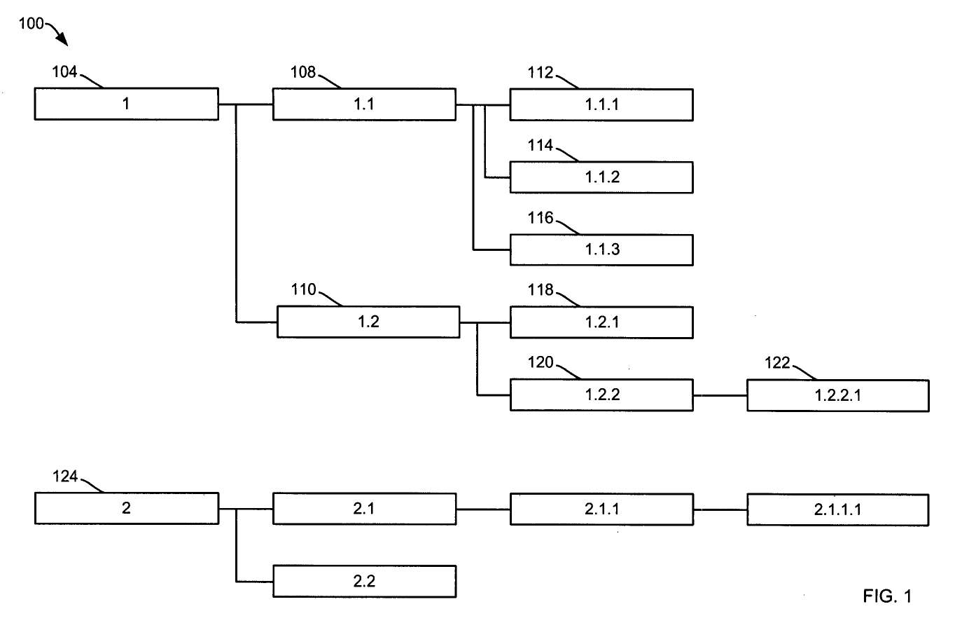

FIG. 1 is a graphical illustration representing a hierarchically organized tree. In the example illustrated two hierarchical parents (104, 124) are illustrated having four levels of hierarchy each. It can be appreciated that many more parents having many more levels may be contemplated under the present invention and that the illustration as shown is not intended to be limiting in any way. A first hierarchical parent 104 is illustrated having a first child 108 and second child 110. Also shown are grandchildren 112-120 and great grandchild 122. In this example, the hierarchy may illustrate a product object hierarchy where a first hierarchical parent 104 may represent a product family. The parent 104 as illustrated has two progeny or children 108, 110 which may represent a product sub-family. These children, in turn have progeny, or grandchildren 112-120 which may represent a product. Finally, child progeny 120 may have a progeny or great grand child 122 which may represent a component. As noted above, the application of nomenclature to a hierarchy is user dependent and may encompass many different combinations as contemplated under the present invention.

Various relationships may be defined under the present example. One relationship example is inheritance. In this example, component 122 inherits attributes of the product family 104 through child 110 and grandchild 120. Thus, component 122 may be thought of as a subset or subtype of product family 104. It can be appreciated that a hierarchical structure need not be balanced. That is, there need not be an equal division of progeny from any parent. For example, as illustrated, child 108 has three progeny 112-116 while child 110 has only two progeny 118-120. Generally, however, inheritance from two parents at a same level is not allowed. For example, progeny 112-116 inherits from child 108 and not from child 108's sibling child 110. Thus, by maintaining inheritance relationships, a user may successfully navigate and operate upon a hierarchy.

Within the context of the present invention, modifying inheritances on an ad hoc basis may be desirable where a user desires to utilize the efficiencies and consistencies associated with hierarchies while also retaining the flexibility to modify object properties as dictated by external influences like, for example, market fluctuation, bidding negotiations, or any other related externality. So, for example, if a hierarchical object 118, having an inherited property, is modified according to user preferences, its sibling object 120 along with sibling object's 120 progeny object 122 may remain unaffected by a modification of object 118's inherited property. Furthermore, object 110 may remain unaffected by modification of its progeny. A modification of a previously inherited property may be therefore illustrated without affecting rules of inheritance and therefore underlying logic corresponding to those rules.

General Application

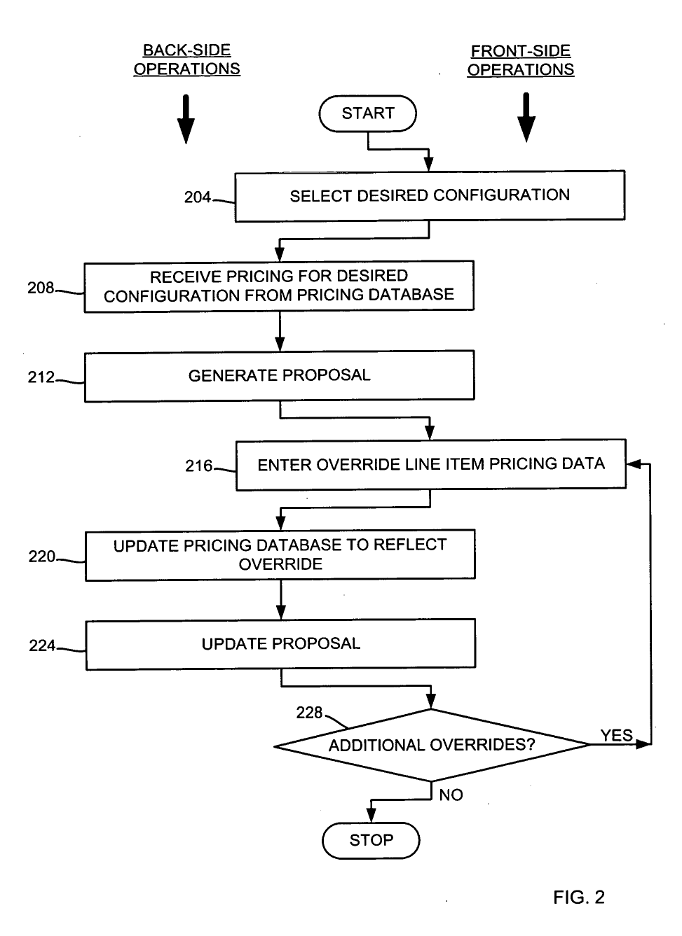

FIG. 2 is a flowchart representing a method of making overrides in a hierarchically organized pricing model according to an embodiment of the present invention. The illustrated steps of FIG. 2 may be defined as either front-side operations or back-side operations. Front-side operations may include all operations conducted by a user. Back-side operations may include all operations conducted automatically. At a first step 204, a configuration may be selected. In a price modeling context, for example, any number of products may be selected according to buyer specifications. For example, a selected configuration may necessarily conform to a selection of gears as components of a larger assembly. In some embodiments, a fine level of granularity with respect to a product family is desirable. In other embodiments, a coarser level of granularity is desirable depending on user preferences. In the coarser granularity example, a family of gears may be selected instead of a gear itself. This is particularly useful where product families are evolving. For example, new material science may lead to an innovative gear made of a lighter and stronger material. A gear made of the lighter and stronger material may not have arrived at market at the time of bid and thus cannot be accounted for as a specific line item in a selected configuration for a quotation. Thus, a finer level of granularity may not be possible at the time of initial bidding. However, once the gear arrives at market, or is available for an more exact bid, then that pricing data may be entered and thus, a finer level of granularity may be achieved. In both illustrated examples, the level of granularity may correspond with a hierarchical structure as illustrated in FIG. 1. That is, as a hierarchical tree is traversed down from its root to its leaves, the level of granularity becomes increasingly finer.

When a desired configuration has been selected, pricing may be received from a pricing database at a step 208. This step may be defined as a back-side operation. A pricing database may include any number of parameters necessary to set appropriate pricing. For example, a pricing database may include a list price, a volume discount, a regional discount, a margin or any other term well known in the art. A pricing database may be local or remote depending on the user configuration and arrangement of data storage services. Because selections made at step 204 represent objects, pricing data (e.g., discounts) may be applied to selections according to rules of inheritance. Thus, for example, a 10% discount of a root level object will apply to all lower level objects of the same branch of a hierarchical tree. From a logical standpoint, no other information regarding a 10% discount is needed since each lower level object merely reflects a discount of its parent. In this manner, pricing data may be more efficiently manipulated and maintained as noted above.

After pricing has been received at a step 208, a proposal may be generated in step 212. This step may be defined as a back-side operation. In some examples, as noted above, not all pricing information may be available. That is, pricing information for some selected configuration components may not exist. In that instance, only inherited properties, such as discounts and the like may be displayed in a proposal. In some embodiments, objects not having pricing data may be filled with data from lower levels of a hierarchy.

Generally speaking, within a negotiating context, a proposal may represent only a first step in a series of negotiations. Negotiations may run anywhere from a few minutes to a few days, months, or years. In that time, many concessions and demands may be made. Furthermore, externalities, as discussed above, may require adjustments to a proposal. Therefore, at a step 216, a proposal may be adjusted by overriding line item pricing data. This step may be defined as a front-side operation.

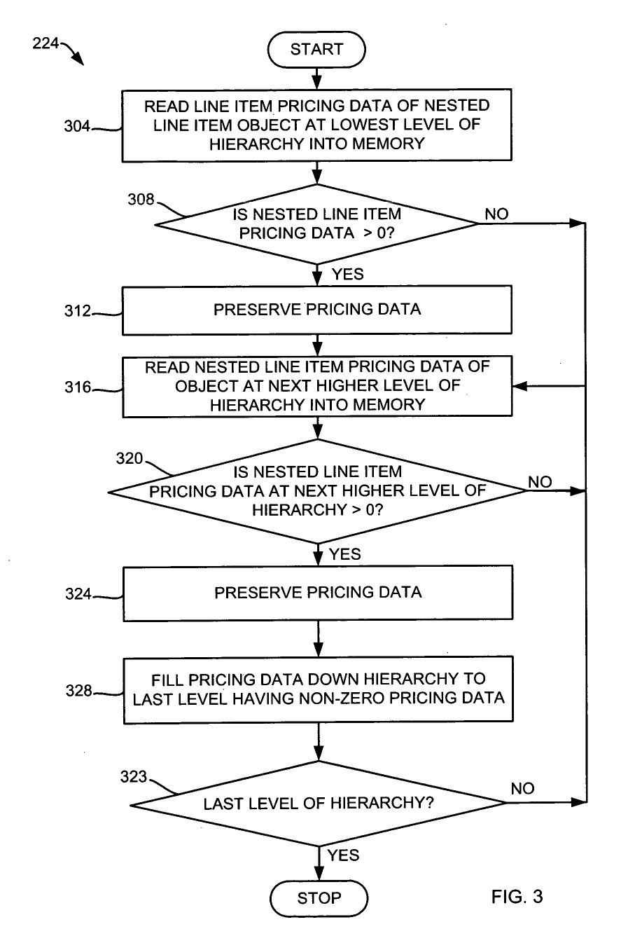

In one embodiment, adjustments may be made at any level of a hierarchically organized pricing model. Thus, in an embodiment, an adjustment may be made at any root level or at any progeny level. In some examples, an increasing level of granularity is preferred as a bid is negotiated. That is, as a bid becomes more refined, levels of detail increase until prices for each nested line item may be resolved. After overrides are entered a pricing database may be updated at a step 220 and a proposal may be updated at a step 224 to reflect overrides. As can be appreciated, steps 220 and 224 are not temporally limited such that those steps may be accomplished in any order. Step 224 is discussed in further detail below for FIG. 3. Both steps 220 and 224 may be defined as back-side operations.

At a step 228, the method determines whether more overrides are necessary. This step may be defined as a front-side operation. If a user determines that more overrides are necessary at a step 228, as in the example of continuing negotiations, the method returns to a step 216 and continues. If no additional overrides are necessary at a step 228, the method ends.

Step 224: Update Proposal

FIG. 3 is a flowchart representing generating a proposal according to an embodiment of the present invention. In particular, FIG. 3 is further illustrative of a step 224 (i.e. UPDATE PROPOSAL) of FIG. 2. In one embodiment, step 224 represents a back-side operation. That is, the updating of a proposal is transparent to the user and may involve automated responses within a computing system. At a first step 304, line item pricing data of a nested line item object at a lowest level of a hierarchy is read. As noted above, objects may be organized hierarchically where progeny of a root object may inherit certain properties from a root object. Pricing data is one example of inherited properties. Line item pricing data may include any of a number of different values including, but not limited to discount data, pricing data, margin data, and waterfall data. If, at a step 308, a nested line item datum has a value as input by a user or automatically configured, the method proceeds to preserve the pricing data read into memory. The determination of whether a value exists may be accomplished in any number of manners well known in the art including without limitation logical argument, or Boolean argument.

If nested line item data has a value >0, line item pricing data of a nested line item object at a next higher level of a hierarchy is read into memory at a step 316. After data is preserved at a step 312, line item pricing data of a nested line item object at a next higher level of a hierarchy is read into memory at a step 316. The method may then determine whether the nested line item pricing data has a value >0 at a step 320. If it is determined that nested line item pricing data does not have a value >0, the method then returns to a step 316 and proceeds as described. If it is determined that nested line item pricing data has a value >0, then nested line item pricing data from that level is preserved at a step 324. Data is then filled down a hierarchy to, but not including, a level having non-zero nested line item pricing data at a step 328. In this manner, all nested line item pricing data not having values >0 may be filled, but lower hierarchical pricing data may be preserved. The method then proceeds to a step 323 where it is determined whether all levels of a hierarchy have been read. If there remain levels of hierarchy, the method proceeds to a step 316 whereupon the method continues as described. If all levels of a hierarch have been read, the method ends.

### EXAMPLE

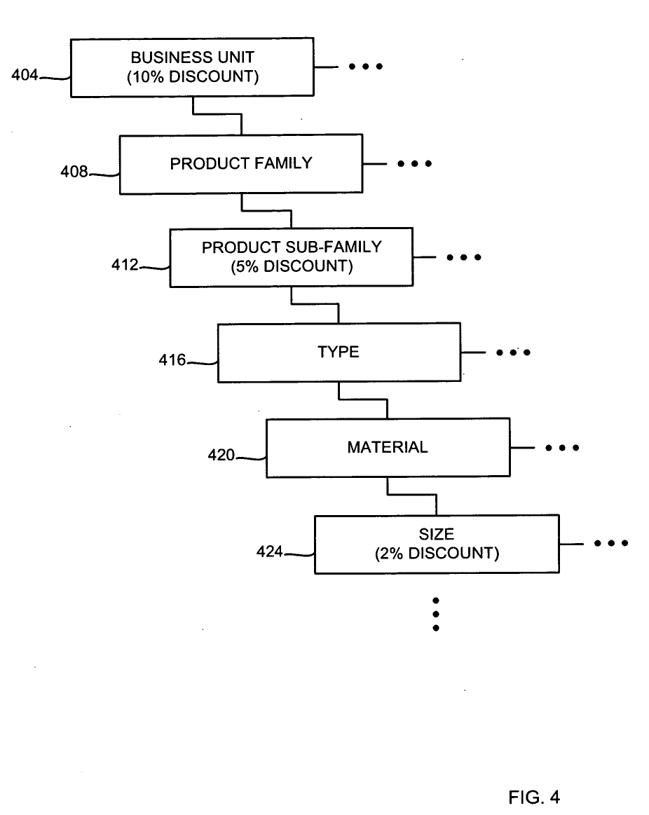

In order to more fully illustrate the above method, a working example is now described. FIG. 4 is an example hierarchy of nested lined items objects along with sample data in one embodiment of the present invention. As can be appreciated, a hierarchical structure may be configured with many more levels and many more elements at each level as indicated by the ellipses as illustrated. In this example of a hierarchy, nested line item objects include, business unit 404, product family 408, product sub-family 412, type 416, material 420, and size 424. The illustrated designations for these objects are for illustrative purposes only and should not be construed as limiting in any way. Further illustrated are a 10% discount for object 404, 5% discount for object 412, and 2% discount for object 424 which represent example pricing data for corresponding objects 404, 412, and 424.

Referring now both to FIGS. 3 and 4, at a step 304, nested line item pricing data of object 424 is read into memory. The method then determines that nested line item pricing data (e.g., 2% discount) is >0 at a step 308. Because nested line item pricing data of object 424 has a value >0, nested line item pricing data is preserved at a step 312. At a next step 316, nested line item pricing data of object 420 is read into memory. The method then determines that the value of nested line item pricing data of object 420 is not >0 at a step 320 whereupon the method continues to a step 316 to read nested line item pricing data of object 416 into memory. The method then determines that nested line item pricing data of object 416 does not have a value >0 at a step 320 whereupon the method continues to a step 316 to read nested line item pricing data of object 412. The method then determines that the value of nested line item pricing data of object 412 is >0 at a step 320. The nested line item pricing data for object 412 is preserved and the hierarchy is filled downward with the nested line item pricing data of object 412 until an object having non-zero nested line item pricing data is reached. In particular, objects 416 and 420 will be filled with a 5% discount. The method then determines whether the current level (i.e., the level at which object 412 exists) is the last level of the hierarchy (it is not in this example) whereupon the method continues to a step 316 to read nested line item pricing data of object 408. The method then determines that the value of nested line item pricing data of object 408 is not >0 at a step 320 whereupon the method continues to a step 316 to read nested line item pricing data of object 404 into memory. The method then determines that the value of nested line item pricing data of object 404 is >0 at a step 320. The nested line item pricing data for object 404 is preserved and the hierarchy is filled downward with the nested line item pricing data of object 404 until an object having non-zero nested line item pricing data is reached. In particular, object 408 will be filled with a 10% discount. The method then determines that the last level of hierarchy has been reached at a step 323 whereupon the method ends.

Thus, in this example, a hierarchically organized tree containing objects may be traversed upwardly to enter nested line item pricing data that would otherwise simply inherit their values according to rules of inheritance.

Step 224. Update Proposal—Alternate Embodiment

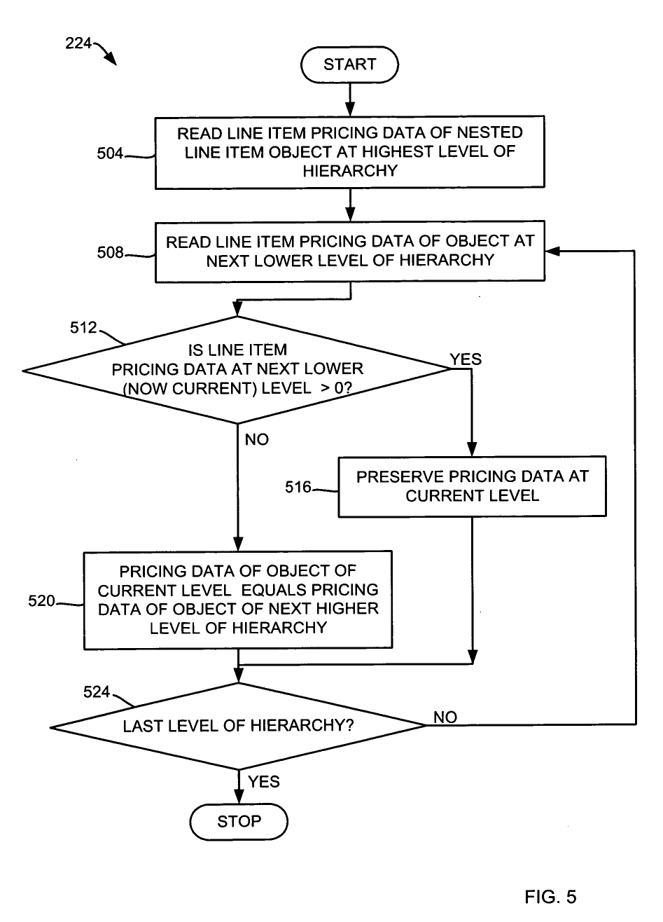

In other embodiments of the present invention, a hierarchically organized tree containing objects may be traversed in a downward direction. FIG. 5 is a flowchart representing a generating a proposal according to an embodiment of the present invention. In particular, FIG. 5 is further illustrative of an alternate method of achieving step 224 (i.e. UPDATE PROPOSAL) of FIG. 2. In one embodiment, step 224 represents a back-side operation. That is, the updating of a proposal is transparent to the user and may involve automated responses within a computing system. At a first step 504, line item pricing data of nested line item object at a highest level of hierarchy (i.e. root level) is read. At a next step 508, line item pricing data of nested line item object at a next lower level of hierarchy (i.e. progeny level) is read. The method then determines whether the value of nested line item pricing data at a progeny level is >0. If nested line item pricing data is >0, then nested line item pricing data at that level is preserved at a step 516 whereupon the method continues to a step 508. If it is determined that the value of nested line item pricing data is >0, then nested line item pricing data for that level will inherit nested line item pricing data from the level directly above it at a step 520. The method then determines whether a last level of a hierarchy has been reached at a step 524. If a last level has not been reached, the method continues to a step 508 and proceeds as discussed above. If a last level has been reached, the method ends.

### EXAMPLE

In order to more fully illustrate the above method, a working example is now described. FIG. 4 is an example hierarchy of nested lined items objects along with sample data in one embodiment of the present invention. As can be appreciated, a hierarchical structure may be configured with many more levels and many more elements at each level as indicated by the ellipses as illustrated. In this example of a hierarchy, nested line item objects include, business unit 404, product family 408, product sub-family 412, type 416, material 420, and size 424. The illustrated designations for these objects are for illustrative purposes only and should not be construed as limiting in any way. Further illustrated are a 10% discount for object 404, 5% discount for object 412, and 2% discount for object 424 which represent example pricing data for corresponding objects 404, 412, and 424.

Referring now both to FIGS. 4 and 5, at a step 504, nested line item pricing data of object 404 is read into memory. Nested line item pricing data for object 404, as illustrated, is 10% discount. At a next step 508, line item nested line item pricing data of object 408 is read. The method then determines, at a step 512, that the value of nested line item pricing data of object 408 is not >0. Data from object 404 is then passed to object 408 at a step 520. Even though nested line item pricing data is passed at step 520 to object 408, object 404 retains its original nested line item pricing data. The method then returns to a step 508 where nested line item pricing data for object 412 is read. The method then determines that the value of nested line item pricing data of object 412 is >0 (i.e., 5% discount) at a step 512. Thus, nested line item pricing data of object 412 is preserved at a step 516 whereupon the method continues to a step 508 where nested line item pricing data of object 416 is read. The method then determines that the value of nested line item pricing data of object 416 is not >0. Data from object 412 is then passed to object 416 at a step 520. The method then returns to a step 508 where nested line item pricing data for object 420 is read. The method then determines that the value of nested line item pricing data of object 420 is not >0. Data from object 416 is then passed to object 420 at a step 520. The method then returns to a step 508 where nested line item pricing data for object 424 is read. The method then determines that the value of nested line item pricing data for object 424 is >0 whereupon the nested line item pricing data is preserved at a step 516. The method then determines that object 424 represents a last level in a hierarchy at a step 524 and ends.

User Interface

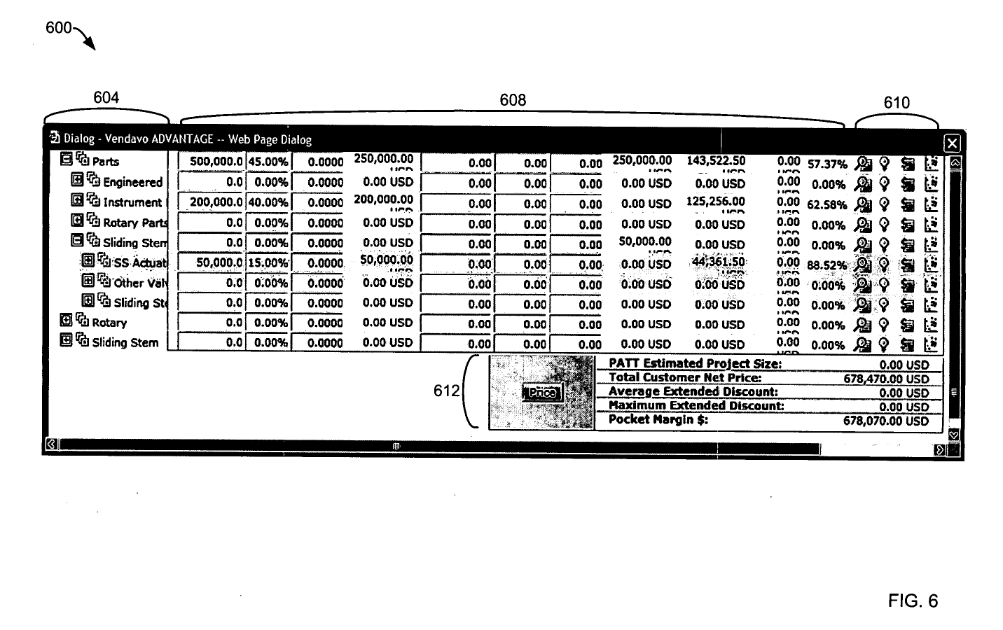

FIG. 6 is an example user interface in accordance with an embodiment of the present invention. A user interface 600 may be graphically displayed as illustrated. A hierarchical directory 604 may be displayed as shown. Nested items may be collapsed or expanded depending on user preferences. Navigation through hierarchical directories may be accomplished in any manner well known in the art without departing from the present invention. A number of fields corresponding to each level of hierarchical directory 604 are presented in section 608. Any number of corresponding fields may be utilized without limitation including, for example, a price field, a discount field, a quantity field, a subtotal field, etc. Fields may be manually or automatically filled. Navigation icons as illustrated in section 610 may also be incorporated to increase the utility of the present invention. Further, calculated fields in section 612 may also be utilized. In this example, several desired calculated fields are illustrated. The fields so illustrated are not intended to be limiting in any way.

While this invention has been described in terms of several preferred embodiments, there are alterations, modifications, permutations, and substitute equivalents, which fall within the scope of this invention. It should also be noted that there are many alternative ways of implementing the methods and apparatuses of the present invention.

It is therefore intended that the following appended claims be interpreted as including all such alterations, modifications, permutations, and substitute equivalents as fall within the true spirit and scope of the present invention.

What is claimed is:

1. A method of overriding inherited pricing structure properties in a hierarchically organized integrated price adjustment system comprising:
providing at least two hierarchically organized product line pricing structures in a common inheritance path wherein one hierarchically organized product line pricing structures is a root level product line pricing structure and wherein all other hierarchically organized product line pricing structures are configured to inherit at least one property from the root level product line pricing structure;
modifying, by user input, one of the at least one properties of any of the at least two hierarchically organized product line pricing structures;
updating all hierarchically organized product line pricing structures above the product line pricing structure having the modified property wherein only product line pricing structures in the common inheritance path are updated such that hierarchical inheritance is overridden.

2. The method of claim 1 wherein the product line pricing structures are configured to correspond to line item pricing data.

3. The method of claim 1 wherein the at least one property corresponds to a line item price.

4. The method of claim 1 wherein the at least one property corresponds to a discount.

5. A system for overriding inherited pricing structure properties in a hierarchically organized integrated price adjustment system comprising:
a database populated with objects representing products in at least one product line wherein the objects are hierarchically organized within related product line hierarchies and wherein the objects are configured to inherit at least one inherited pricing structure property;
a user interface configured to allow at least one inherited pricing structure property in the least one product line to be modified in accordance with user preferences; and
an update engine that overrides all inherited pricing structure properties of all objects above the object having the at least one modified pricing structure property in the related product line hierarchy.

6. The system of claim 5 further comprising:
a quotation incorporating all overriding inherited pricing structure properties and all inherited pricing structure properties.

7. The system of claim 5 wherein the products further include services.

8. The method of claim 5 wherein the products in at least one product line are configured to correspond to line item pricing data.

9. The method of claim 5 wherein the at least one inherited pricing structure property corresponds to a line item price.

10. The method of claim 5 wherein the at least one inherited pricing structure property corresponds to a discount.

11. A computer program product in a computer readable media for overriding inherited pricing structure properties in a hierarchically organized integrated price adjustment system, the computer program product comprising:
a database populated with objects representing products in at least one product line wherein the objects are hierarchically organized within related product line hierarchies and wherein the objects are configured to inherit at least one inherited pricing structure property;
a user interface configured to allow at least one inherited pricing structure property in the least one product line to be modified in accordance with user preferences; and
an update engine that overrides all inherited pricing structure properties of all objects above the object having the at least one modified pricing structure property in the related product line hierarchy.

12. A method of overriding inherited object properties in a hierarchically organized integrated price adjustment system comprising:
providing at least two hierarchically organized objects in a common inheritance path wherein one hierarchically organized object is a root level object and wherein all other hierarchically organized objects are configured to inherit at least one property from the root level object;
modifying, by user input, one of the at least one properties of any of the at least two hierarchically organized objects;
updating all hierarchically organized objects above the object having the modified property wherein only objects in the common inheritance path are updated such that hierarchical inheritance is overridden.

13. The method of claim 12 wherein the hierarchically organized objects correspond to a product line.

14. The method of claim 12 wherein the objects are configured to correspond to line item pricing data.

15. The method of claim 12 wherein the at least one property corresponds to a line item price.

16. The method of claim 12 wherein the at least one property corresponds to a discount.
